(19) United States
(12) Patent Application Publication
(10) Pub. No.: US 2026/0020106 A1
(43) Pub. Date: Jan. 15, 2026

(54) METHOD FOR DEACTIVATING IN-VEHICLE CONNECTIVITY OF A VEHICLE

(71) Applicant: Robert Bosch GmbH, Stuttgart (DE)

(72) Inventors: Paulius Duplys, Markgroeningen (DE); Stefan Kriso, Oberriexingen (DE)

(21) Appl. No.: 19/232,294

(22) Filed: Jun. 9, 2025

(30) Foreign Application Priority Data
Jun. 12, 2024 (DE) 10 2024 205 385.6

(51) Int. Cl. H04W 76/38; B60R 16/02; H04W 4/40

(52) U.S. Cl. CPC H04W 76/38; B60R 16/02; H04W 4/40

(57) ABSTRACT

A method for deactivating in-vehicle connectivity of a vehicle. The method includes: providing the in-vehicle connectivity of the vehicle for at least one vehicle function, wherein the in-vehicle connectivity provides a wireless connection of the vehicle to the Internet via a component of the vehicle; deactivating the in-vehicle connectivity after a defined time period. A system, a computer program, a device, and a storage medium, are also described.

### FIELD

The present invention relates to a method for deactivating in-vehicle connectivity of a vehicle. The present invention further relates to a system, a computer program, a device and a storage medium for this purpose.

### BACKGROUND INFORMATION

With the Product Safety Regulation (2023/988, valid in the EU as from 13 Dec. 2024), the following aspect, among others, must be taken into account when assessing whether the product is a safe product: when required by the nature of the product, the appropriate cybersecurity features necessary to protect the product against external influences, including malicious third parties, where such an influence might have an impact on the safety of the product, including the possible loss of interconnection. [2033/988, Article 6, sentence 1, paragraph (g)].

Here, for the first time, a direct regulatory connection between safety and security is established: a product can be deemed insufficiently safe if cybersecurity measures are missing and this results in a safety-critical event. This may then result in appropriate field measures (e.g., recall). In case of very long product lifespans, the possible loss of interconnection (see above) may possibly no longer be remedied by a software update (including over-the-air), but hardware measures may also be necessary, e.g., if the connectivity technology is no longer available.

Nowadays, the established method for closing security vulnerabilities in products in the field is based on software updates: the vulnerability is fixed in the source code and the new software version is installed on the product-typically via an over-the-air connection. However, the update capability of an (embedded) product depends on its hardware and decreases over time as the software becomes larger and more complex, while the hardware remains the same and thus limited in terms of performance. After a relatively short time, an update is no longer technically possible due to this limitation. For example, smartphones are provided with updates only for a few years. Such periods are far too short for the automotive sector; a typical vehicle lifespan is 10-15 years. Therefore, updates alone will not be sufficient to implement the Product Safety Regulation described above in the long term.

### SUMMARY

The present invention includes, among other things, a method, a system, a computer program, a data processing device, and a computer-readable storage medium. Features and details of the present invention are disclosed herein. Features and details that are described in connection with the method according to the present invention of course also apply in connection with the system according to the present invention, the computer program according to the present invention, the data processing device according to the present invention, and the computer-readable storage medium according to the present invention, and vice versa in each case, so that mutual reference can also always be made with regard to the disclosure of the present invention.

The present invention is in particular a method for deactivating in-vehicle connectivity of a vehicle. According to an example embodiment of the present invention, the method comprises the following steps, wherein the steps can be performed repeatedly and/or successively. In principle, the method according to the present invention can also be applied in other technical systems, provided that there is a long product life cycle, e.g., of 10 years or more, and no change of hardware of the technical system is possible or provided. Within the scope of the present invention, in-vehicle connectivity is to be understood in particular as a connectivity provided within the vehicle for connecting the vehicle to the outside, for example to the Internet or to further vehicles.

In a first step, the in-vehicle connectivity of the vehicle is preferably provided for at least one vehicle function, wherein the in-vehicle connectivity provides a wireless connection of the vehicle to the Internet via a component of the vehicle. The at least one vehicle function can, for example, be an autonomous vehicle function in which the vehicle is networked with at least one further vehicle or road user. The at least one vehicle function can also be an update function with which the vehicle's software is kept up to date. It can also be a function executed entirely or partially in the edge or cloud infrastructure. For example, it would be possible to enrich route suggestions with data from highly accurate road maps in the cloud. For example, maps are being considered that contain road surface conditions or the probability of icing. The component can be, for example, a central control unit (CCU) of the vehicle, and can also use a SIM card to provide the vehicle's wireless connection to the Internet.

In a further step, the in-vehicle connectivity is preferably deactivated after a defined time period. The defined time period can, for example, be defined by a manufacturer of the vehicle. This can advantageously ensure that security is still provided even after the defined time period, since attacks on the vehicle via the Internet can be prevented by means of the in-vehicle connectivity.

Using the method according to the present invention, responsibility for security of the connectivity can advantageously be transferred to the end customer or their terminal after the defined time period, where updates can be implemented significantly more cost-efficiently. The vehicle manufacturer's responsibility for connectivity software updates can therefore advantageously end after the defined time period.

Advantageously, risks for both the end customer and the vehicle manufacturer and for society can therefore be better controlled, as they automatically decrease over time.

Within the scope of the present invention, it is further possible for the deactivation of the in-vehicle connectivity to take place irreversibly, in particular by melting at least one fuse and/or deleting at least one certificate and/or at least one software measure. This can advantageously ensure that the in-vehicle connectivity cannot be subsequently reactivated, for example by an attacker. Irreversible deactivation could be carried out by the vehicle manufacturer, for example via a cloud server connection.

According to an example embodiment, it can be provided within the scope of the present invention for the method to further comprise the step of:
providing backup connectivity for the at least one vehicle function, wherein the backup connectivity provides the wireless connection of the vehicle to the Internet via a terminal, the terminal being connected to the vehicle for this purpose,
initiating a switch from the deactivated in-vehicle connectivity to the provided backup connectivity.

According to an example embodiment of the present invention, the terminal can be, for example, a smartphone that is connected to the vehicle via Bluetooth or a cable such as USB. This means that the vehicle can advantageously still be connected to the Internet and, for example, be provided with software updates to stay up to date and correct errors. This advantageously allows an end customer to fully retain the functionality of the at least one vehicle function using the terminal despite the irreversible deactivation of the in-vehicle connectivity. In this way, software downloads, for example, can at least still be carried out with a time delay.

According to an example embodiment of the present invention, it may be provided for the backup connectivity to also be deactivated within the scope of deactivating the in-vehicle connectivity. This can be carried out after a second defined time period or initiated by a trigger such as an emergency, for example if a security gap in the vehicle or at least one vehicle function is detected or becomes known.

Optionally, it is also possible for the deactivation to take place reversibly in order to provide situation-dependent deactivation and activation of the in-vehicle connectivity. Switching to the provided backup connectivity can preferably also take place, i.e., if the in-vehicle connectivity is deactivated the backup connectivity is preferably activated, and vice versa. “Reversible” therefore means in particular that the in-vehicle connectivity can be reactivated. This can be implemented, for example, by means of a combination of persistent memory such as FLASH and a shadow register. Depending on the situation, this can mean, for example, that the in-vehicle connectivity is deactivated for a certain period of time, e.g., if a security gap regarding the vehicle or the at least one vehicle function has become known or has been detected. The in-vehicle connectivity could also be reversibly deactivated during maintenance or repair work or while the vehicle is located in a specific geographical region or country. The in-vehicle connectivity could be reversibly deactivated even if the vehicle's connection to the Internet via the in-vehicle connectivity does not meet at least one defined requirement, e.g., regarding a bandwidth or latency. The reversible deactivation could be carried out by the vehicle manufacturer via a cloud server connection or via a corresponding module of the vehicle such as vehicle diagnostics or via a vehicle menu.

Furthermore, according to an example embodiment of the present invention, it can be provided for the deactivation to be further initiated by at least one trigger. Both the irreversible deactivation and reversible deactivation can be initiated by the at least one trigger. The at least one trigger could be the discovery of a security gap, or a manual trigger by a specialist such as an employee of the vehicle manufacturer or a corresponding service provider or workshop employee. The deactivation can be carried out manually, for example by means of a vehicle module such as vehicle diagnostics, or via a vehicle menu. A trigger could also be provided by a sensor, in particular a GPS sensor that ascertains a current region of the vehicle. In addition, a trigger could be the meeting of at least one defined requirement regarding a connection to the Internet by means of the in-vehicle connectivity, e.g., a bandwidth or latency.

The present invention also relates to a system for restricting the connectivity of a vehicle, comprising:
a demultiplexer for providing in-vehicle connectivity and/or backup connectivity, and
a switch having a timer module to control the demultiplexer.

The system is designed in particular to carry out the method according to the present invention. The system according to the present invention thus entails the same advantages as described in detail with reference to the method according to the present invention.

The in-vehicle connectivity is provided in particular using a component of the vehicle, for example a central control unit (CCU) of the vehicle, and can also use a SIM card to provide a wireless connection of the vehicle to the Internet. The backup connectivity provides, in particular, the wireless connection of the vehicle to the Internet via a terminal, the terminal preferably being connected to the vehicle for this purpose. For example, the terminal can be a smartphone and be connected to the vehicle via Bluetooth or USB. The demultiplexer is used in particular to switch an input, which originates from the vehicle function according to the present invention, to one of several outputs, i.e., in particular to the in-vehicle connectivity or backup connectivity. For control purposes, the demultiplexer has in particular a control input that can be controlled with the switch. The timer module specifies in particular the defined time period and, if applicable, also the second defined time period according to the present invention, so that after the defined time period has elapsed, a corresponding signal can trigger the deactivation of the in-vehicle connectivity, and, if applicable, after the second defined time period has elapsed, a corresponding signal can trigger the deactivation of the backup connectivity.

According to an example embodiment of the present invention, it is furthermore advantageous if the switch further comprises a policy module and/or an emergency module for controlling the demultiplexer depending on at least one trigger. The policy module can take into account at least one policy, such as GPS coordinates of the vehicle, a network used or a quality (bandwidth, latency, etc.) of a connection to the Internet by means of the in-vehicle connectivity. Using the emergency module, the in-vehicle connectivity and, if applicable, also the backup connectivity can be deactivated manually (e.g., by workshop personnel or the vehicle owner) or automatically (e.g., as a result of a specific situation). Such automated deactivation can occur through a signal (in particular a message) from a backend of the vehicle manufacturer (OEM). For example, if a critical vulnerability is reported to the OEM but the OEM cannot patch it immediately, it may be useful to deactivate the affected vehicle functions or restrict their connectivity until the vulnerability is patched. Alternatively, an intrusion detection system could initiate such automated deactivation, for example if known attacks, e.g., on the vehicle diagnostic interface OBDII, are detected. The at least one trigger is therefore in particular the at least one policy and/or the specific situation. The specific situation can be determined, for example, through sensor data or vehicle calculations.

It is possible for the method according to the present invention to be used in a vehicle. The vehicle may be configured, for example, as a motor vehicle and/or passenger vehicle and/or autonomous vehicle. The vehicle may comprise a vehicle mechanism, for example for providing an autonomous driving function, and/or a driver assistance system. The vehicle mechanism may be designed to at least partially automatically control and/or accelerate and/or brake and/or steer the vehicle.

The present invention also relates to a computer program, in particular a computer program product, comprising commands which, when the computer program is executed by a computer, cause the computer to carry out the method according to the present invention. The computer program according to the present invention thus delivers the same advantages as have been described in detail with reference to a method according to the present invention.

The present invention also relates to a device for processing data that is configured to carry out the method according to the present invention. For example, a computer which executes the computer program according to the present invention can be provided as the device. The computer can have at least one processor for executing the computer program. A non-volatile data memory can also be provided, in which the computer program is stored and from which the computer program can be read by the processor for execution.

The present invention also relates to a computer-readable storage medium which comprises the computer program according to the present invention and/or commands which, when executed by a computer, cause the computer to carry out the method according to the present invention. The storage medium is formed, for example, as a data memory such as a hard drive and/or a non-volatile memory and/or a memory card. The storage medium can be integrated into the computer, for example.

Furthermore, the method according to the present invention can also be designed as a computer-implemented method. Alternatively or additionally, at least one of the disclosed method steps can be computer-implemented and/or performed automatically.

Further advantages, features and details of the present invention can be found in the following description, in which exemplary embodiments of the present invention are described in detail with reference to the figures. The features mentioned in herein can be essential to the present invention in each case, either individually or in any combination.

### BRIEF DESCRIPTION OF THE DRAWINGS

FIG. 1 is a schematic visualization of a method, a vehicle, a device, a storage medium and a computer program according to exemplary embodiments of the present invention.

FIG. 2 is a schematic representation of a system according to exemplary embodiments of the present invention.

### DETAILED DESCRIPTION OF EXAMPLE EMBODIMENTS

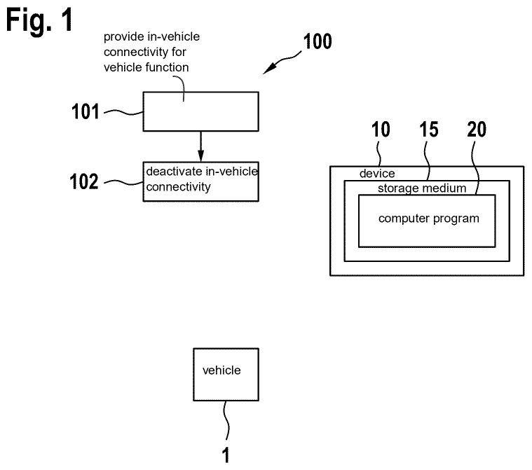

FIG. 1 schematically shows a method 100, a vehicle 1, a device 10, a storage medium 15 and a computer program 20 according to exemplary embodiments of the present invention.

In particular, FIG. 1 shows an exemplary embodiment of a method 100 for deactivating in-vehicle connectivity of a vehicle 1. In a first step 101, the in-vehicle connectivity of the vehicle 1 is provided for at least one vehicle function 9, wherein the in-vehicle connectivity provides a wireless connection of the vehicle 1 to the Internet via a component 2 of the vehicle 1. In a second step 102, the in-vehicle connectivity is deactivated after a defined time period.

The present invention is based on the following observation according to exemplary embodiments: the most important prerequisite for cyberattacks in practice is in particular connectivity of vehicles, because scalable remote attacks, e.g., via the Internet, are only possible through connectivity. If an attacker requires physical access to the vehicle, the costs associated with the attack can be significantly higher and the requirements significantly more extensive, which can prevent scalable attacks and generally significantly reduce the probability of an attack.

According to exemplary embodiments of the present invention, a mechanism is described which degrades connectivity in a systematic manner such that the vehicle is adequately protected against cyberattacks throughout its entire lifetime in such a way as to sufficiently avoid safety impacts. In systems according to the related art, there is, in particular, only “either-or”: connectivity is either realized in the vehicle, e.g., via a SIM card in the vehicle, or it is realized exclusively via the end customer's terminal, e.g., via a Bluetooth connection to the vehicle. Our proposal combines the two approaches: the in-vehicle connectivity degrades after a certain period of time to connectivity via the end-customer terminal.

Vehicles can initially provide connectivity as in-vehicle connectivity themselves, for example via a built-in SIM card. For a limited period of time, which can be individually determined by a vehicle manufacturer, necessary updates will preferably be carried out via said channel. This means that responsibility for security and, consequently, the associated safety can be the vehicle manufacturer's responsibility. The end customer's expectations of the vehicle may decrease over time, but on the other hand, the security of the connectivity functionality in particular must continue to be guaranteed. Over time, however, an update of the in-vehicle connectivity may become less and less economically reasonable or even technically impossible. According to exemplary embodiments of the present invention, the in-vehicle connectivity is preferably deactivated permanently (e.g., by irreversibly melting fuses, deleting certificates, software measures) and backup connectivity is established by the end customer terminal (e.g., smartphone in the vehicle coupled via Bluetooth).

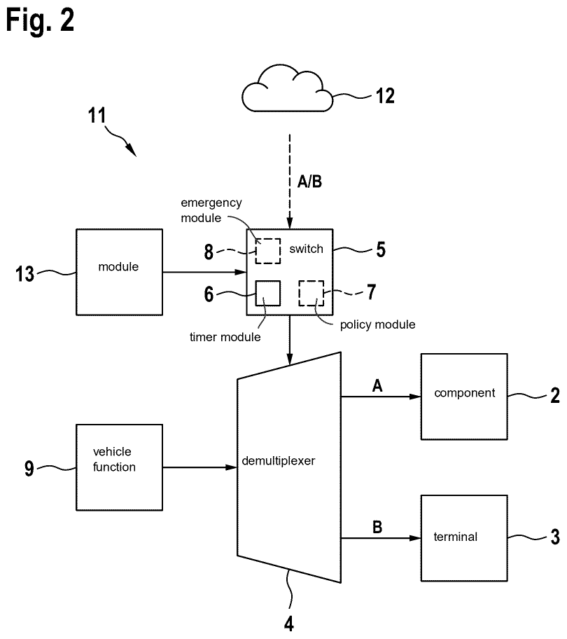

FIG. 2 schematically shows a system 11 according to exemplary embodiments of the present invention. The following description therefore refers in particular to FIG. 2. Dashed lines represent examples of optional elements according to various exemplary embodiments, which can also be combined with each other. An in-vehicle function 9, which preferably uses the in-vehicle connectivity, can be connected by means of a demultiplexer 4 via the path A to a component 2 of the vehicle 1, such as a central control unit (CCU), or via the path B to a terminal 3 (e.g., a smartphone in the vehicle coupled via Bluetooth). The switch 5 determines in particular which of the two paths A and B is active. At the beginning of a vehicle life cycle, the path A in particular is active so that the vehicle function 9 can use the in-vehicle connectivity. During this time, the manufacturer of the vehicle 1 in particular bears responsibility for all security updates and thus also for the associated safety. How long the path A remains active is determined in particular by the timer module 6 built into the switch 5, with which the vehicle manufacturer can define a time period after which the in-vehicle connectivity can be deactivated.

If the defined time period expires, the switch 5 preferably activates the path B and deactivates the path A. From this point onward, the connectivity is no longer provided by the in-vehicle component 2, but by the terminal 3. Therefore, from this point onward, security bugs in the in-vehicle component 2 can preferably no longer be exploited for remote attacks, even if the vehicle manufacturer can no longer patch them by means of an update. On the other hand, a user of the vehicle 1, in particular, is responsible for the secure software version on the terminal 3, and such a software version can also be achieved significantly more easily on the terminal 3, since terminals such as smartphones generally have a significantly shorter lifespan and have greater hardware resources, so that their update capability can be maintained much more easily and the user, e.g., the vehicle owner, has control over that.

Furthermore, in certain cases such as emergencies—for example, if a critical security vulnerability in the hardware of the in-vehicle component 2 becomes known that cannot be patched by a software update-local access to the switch 5 is possible via a corresponding module 13, for example vehicle diagnostics or via a vehicle menu. This means that switching from path A to path B can be carried out manually even before the defined time period of the timer module 6 has elapsed.

The switch 5 could be switched directly by the vehicle manufacturer via a remote connection from the vehicle manufacturer to the vehicle 1, for example via a cloud server 12. This connection can exist directly between the switch 5 and the cloud server 12 of the vehicle manufacturer (as shown in FIG. 2) or via the component 2 of the vehicle (not shown in FIG. 2). To secure the connection from the vehicle manufacturer to the switch 5, TLS can be used together with certificate-based authentication, for example. This option with the cloud server 12 can have the advantage that the vehicle manufacturer can respond promptly to particularly critical security incidents, since a visit to the workshop or interaction with the vehicle owner is not necessary.

According to exemplary embodiments of the present invention, the in-vehicle communication is irreversibly deactivated, e.g., by irreversibly melting fuses, deleting certificates, or software measures. In addition, reversible deactivation of the in-vehicle communication can also be provided, which is implemented, for example, by means of a combination of a persistent memory such as FLASH and a shadow register. This can enable situation-dependent switching from in-vehicle connectivity to backup connectivity by means of the terminal.

In addition to the timer module 6, the switch 5 can also comprise a policy module 7, which can implement significantly more complex policies for switching from path A to path B. Using the policy module 7 it is possible, for example, to switch off the in-vehicle connectivity depending on GPS coordinates of the vehicle, the network or the quality (bandwidth, latency, etc.) of the connection.

The switch 5 can also be supplemented by an additional emergency module 8. The emergency module 8 can be used manually (e.g., by workshop personnel or the vehicle owner) or automatically (e.g., as a result of a specific policy) to completely switch off the in-vehicle connectivity and, if necessary, also the backup connectivity. This can have the advantage that the in-vehicle and, if applicable, also the backup connectivity can be deactivated in the event that a highly critical security vulnerability has been discovered in the vehicle 1 or in the at least one vehicle function 9, but due to the age of the vehicle 1 can no longer be patched or cannot be economically reasonably patched, i.e., by a corresponding update.

Furthermore, it is possible not only to switch from path A to path B, but also—depending on a second defined time period of the timer module 6—to switch off the connectivity completely, e.g., by means of the emergency component 8. In this alternative, there are, in particular, two defined time periods t₀ and t₁, with t₀<t₁. If the first defined time period to has elapsed, the switch 5 preferably switches irreversibly from path A to path B. If the second time period t₁ has elapsed, the switch 5 preferably switches off the connectivity completely and irreversibly. This can have the advantage of limiting the time window for a remote attack by design and irreversibly, both against attacks that exploit security vulnerabilities in the in-vehicle connectivity and against attacks that exploit security vulnerabilities in the vehicle's functionality itself. This means that an attacker has only a limited amount of time to discover vulnerabilities in a vehicle protected in this way. Furthermore, the search for vulnerabilities is significantly less attractive from an economic point of view, since vulnerabilities that can be exploited only for a limited period of time after their discovery yield significantly less revenue. Ultimately, from an economic and societal point of view, the risk of security vulnerabilities and the associated safety impacts can steadily decrease over time. Even if someone finds a so-called zero-day vulnerability and keeps it secret, over time the number of vulnerable vehicles where this vulnerability can be exploited can be advantageously reduced.

Advantages of the present invention according to exemplary embodiments may be, for example, the following. A user, in particular a vehicle owner, can retain full functionality of the vehicle function despite irreversibly deactivating the in-vehicle connectivity if a user's terminal is connected to the vehicle. Since the vehicle itself no longer provides its own in-vehicle connectivity, vehicle functions that could originally be performed in the absence of the driver can now still be carried out, at least with a delay, e.g., software downloads. Responsibility for security of the connectivity can advantageously be transferred to the end customer or their terminal, where updates can be implemented significantly more cost-efficiently. The vehicle manufacturer's responsibility for connectivity software updates can therefore advantageously end after the defined time period or with degradation to the terminal. The manufacturer of the vehicle could, for example, also offer the degradation functionality according to exemplary embodiments of the present invention to the end customer as an optionally selectable feature, i.e., the end customer could be given the opportunity to determine the type of connectivity themselves, e.g., basic connectivity via their own smartphone and in-vehicle connectivity with value-added functions for an additional charge. Advantageously, risks for both the end customer and the vehicle manufacturer and for society can therefore be better controlled, as they automatically decrease over time.

The above description of the embodiments describes the present invention exclusively in the context of examples. Of course, individual features of the embodiments, provided they make technical sense, can be freely combined with one another without departing from the scope of the present invention.

1-11. (canceled)

12. A method for deactivating in-vehicle connectivity of a vehicle, comprising the following steps:
providing the in-vehicle connectivity of the vehicle for at least one vehicle function, wherein the in-vehicle connectivity provides a wireless connection of the vehicle to the Internet via a component of the vehicle; and
deactivating the in-vehicle connectivity after a defined time period.

13. The method according to claim 12, wherein the deactivation of the in-vehicle connectivity takes place irreversibly, by: (i) melting at least one fuse and/or (ii) deleting at least one certificate and/or (iii) at least one software measure.

14. The method according to claim 12, the method further comprising the following steps:
providing backup connectivity for the at least one vehicle function, wherein the backup connectivity provides the wireless connection of the vehicle to the Internet via a terminal, the terminal being connected to the vehicle; and
initiating a switch from the deactivated in-vehicle connectivity to the provided backup connectivity.

15. The method according to claim 14, wherein within the scope of the deactivation, the backup connectivity is also deactivated, after a second defined time period.

16. The method according to claim 14, wherein the deactivation takes place reversibly to provide situation-dependent deactivation and activation of the in-vehicle connectivity.

17. The method according to claim 12, wherein the deactivation is further initiated by at least one trigger.

18. A system for restricting connectivity of a vehicle, comprising:
a demultiplexer configured to provide in-vehicle connectivity and/or backup connectivity; and
a switch having a timer module to control the demultiplexer,
wherein the system is configured to
provide the in-vehicle connectivity of the vehicle for at least one vehicle function, wherein the in-vehicle connectivity provides a wireless connection of the vehicle to the Internet via a component of the vehicle; and
deactivate the in-vehicle connectivity after a defined time period.

19. The system according to claim 18, wherein the switch further includes a policy module and/or an emergency module for controlling the demultiplexer depending on at least one trigger.

20. A device configured to process data and configured for deactivating in-vehicle connectivity of a vehicle, the device configured to perform the following steps:
providing the in-vehicle connectivity of the vehicle for at least one vehicle function, wherein the in-vehicle connectivity provides a wireless connection of the vehicle to the Internet via a component of the vehicle; and
deactivating the in-vehicle connectivity after a defined time period.

21. A non-transitory computer-readable storage medium on which are stored commands for deactivating in-vehicle connectivity of a vehicle, the commands, when executed by a computer, causing the computer to perform the following steps:
providing the in-vehicle connectivity of the vehicle for at least one vehicle function, wherein the in-vehicle connectivity provides a wireless connection of the vehicle to the Internet via a component of the vehicle; and
deactivating the in-vehicle connectivity after a defined time period.
